(19) United States
(12) Patent Application Publication
(10) Pub. No.: US 2008/0040228 A1
(43) Pub. Date: Feb. 14, 2008

(54) Advertising method for website

(76) Inventor: Hector Gutierrez, Fontana, CA (US)

Correspondence Address: LITMAN LAW OFFICES, LTD., P.O. BOX 15035, CRYSTAL CITY STATION, ARLINGTON, VA, 22215, US

(21) Appl. No.: 11/882,675

(22) Filed: Aug. 3, 2007

Related U.S. Application Data
(60) Provisional application No. 60/836,677, filed on Aug. 10, 2006.

(51) Int. Cl. G06Q 30/00

(52) U.S. Cl. 705/14

(57) ABSTRACT

The advertising method for a website is a method by which an incentive is provided on the advertising website to drive users to web pages belonging to advertisers being displayed on the advertising website. When a registered user of the advertising website mouses over a pixel block displaying an advertiser's image, a specific unique coordinate set of the mouse cursor at the time the user clicks on the image is recorded as an entry into a winner selection table. Similarly, a plurality of users may select from the advertising images and, thus, create their own entry into the winner selection table. After a predetermined time, entries are closed and a winning coordinate set is determined. Users who have entries that match the winning coordinate set are notified that they have won a prize, and prizes are distributed accordingly.

### CROSS-REFERENCE TO RELATED APPLICATION

This application claims the benefit of U.S. Provisional Patent Application Ser. No. 60/836,677, filed Aug. 10, 2006.

### BACKGROUND OF THE INVENTION

1. Field of the Invention

The present invention relates to electronic commerce conducted over the Internet, and more particularly to an advertising method for a website by which advertisers on a site located online can drive users to their advertising site by offering the users an incentive to click on the advertisers' link.

2. Description of the Related Art

Advertisements represent a very important source of revenue for Internet information content providers and the like. Generally, advertisements have been displayed as banners, pop-ups, animated areas proximate to non-advertisement type information content, etc. Advertisers must pay for their advertisement display, and generally look for maximum return on their advertising investment dollars. Thus, content providers are always looking for ways to improve the performance of their websites with respect to click-through traffic to the paying advertisers.

Recently, a new advertising model has evolved in which the content provider's webpage is dedicated solely to advertisements. This new advertising model was developed by an enterprising business management student, Alex Tew, of Wiltshire, England. Mr. Tew, being motivated by the desire to finance his education, decided to try to make $1,000,000 USD by selling 1,000,000 pixels for $1 each. He naturally dubbed his website “The Million Dollar Home Page”. Mr. Tew invited everyone to buy his pixels, and made them available in 100-pixel blocks, with each block measuring 10×10 pixels. Mr. Tew's homepage is divided into 10,000 of the 100-pixel blocks, thus totaling 10⁶ pixels.

Mr. Tew chose 100-pixel blocks because it was his thinking that anything smaller would be too small to display a meaningful advertisement. Mr. Tew allowed advertisers to buy as many pixels as they desired, subject to pixel availability. Advertisers then were permitted to display an image/ad/or logo chosen by the advertiser in the space that was purchased. The image was then given the capability to click through to a website designated by the advertiser. The only limitation was that there would be no obscene or offensive images allowed. Mr. Tew even provided a guarantee as to how long (five years) the homepage would be operational.

It goes without saying that Mr. Tew's idea instantly generated a revenue stream for him, as his homepage filled up very quickly with advertiser images. Now his homepage is all filled up and he is not taking any more pixel orders. A cursory inspection of Mr. Tew's homepage reveals that just about every type of product or service imaginable is advertised there. For example, on-line gambling sites, dating sites, money lending sites, other pixel sites, “make money” sites, web-hosting sites, and the like advertise on Mr. Tew's homepage.

Of course, once Mr. Tew successfully demonstrated that a homepage could sell pixel blocks, other sites began to employ the same business model. Such pixel homepage sites have proliferated to the extent that there is now at least one website dedicated to the review of these “pixel sites”.

Some of the “copycat” pixel sites now include porn with naked people in the little pixel blocks. Other pixel sites are designed in the form of cities and streets, also having blimps and planes flying overhead in which an advertiser can advertise on billboards, banners, and the like, in similar fashion to advertising in a real-world city.

There is even described a pixel lottery page in which pixel purchasers are entered in a drawing for up to $5,000 wherein four people will win $1,000. The winning chances increase in proportion to the number of sold pixels. Once the number of pixels sold increases to a threshold amount, a $25,000 prize will be given to one of the pixel advertisers.

There remains a need, however, to fine-tune the pixel advertising page business model to attract browsers, shoppers, and the like, not just the advertisers. It would be desirable to devise a method by which an incentive is provided on the advertising website to drive users to web pages belonging to advertisers being displayed on the advertising website.

Thus, an advertising method for a website solving the aforementioned problems is desired.

### SUMMARY OF THE INVENTION

The advertising method for a website is a method by which an incentive is provided on the advertising website to drive users to web pages belonging to advertisers being displayed on the advertising website. When a registered user of the advertising website mouses over a pixel block displaying an advertiser's image, a specific unique coordinate set of the mouse cursor at the time the user clicks on the image is recorded as an entry into a winner selection table. Similarly, a plurality of users may select from the advertising images, and thus create their own entry into the winner selection table. After a predetermined time, entries are closed and a winning coordinate set is determined. Users who have entries that match the winning coordinate set are notified that they have won a prize, and prizes are distributed accordingly.

These and other features of the present invention will become readily apparent upon further review of the following specification and drawings.

### BRIEF DESCRIPTION OF THE DRAWINGS

FIG. 1A is a screenshot of a partially populated webpage in an advertising method for website according to the present invention.

FIG. 1B is a screenshot of a fully populated webpage in an advertising method for website according to the present invention.

FIGS. 2A and 2B represent a flowchart of the steps of an advertising method for website according to the present invention.

FIG. 3 is a block diagram showing a computer system for an advertising method for website according to the present invention.

Similar reference characters denote corresponding features consistently throughout the attached drawings.

### DETAILED DESCRIPTION OF THE PREFERRED EMBODIMENT

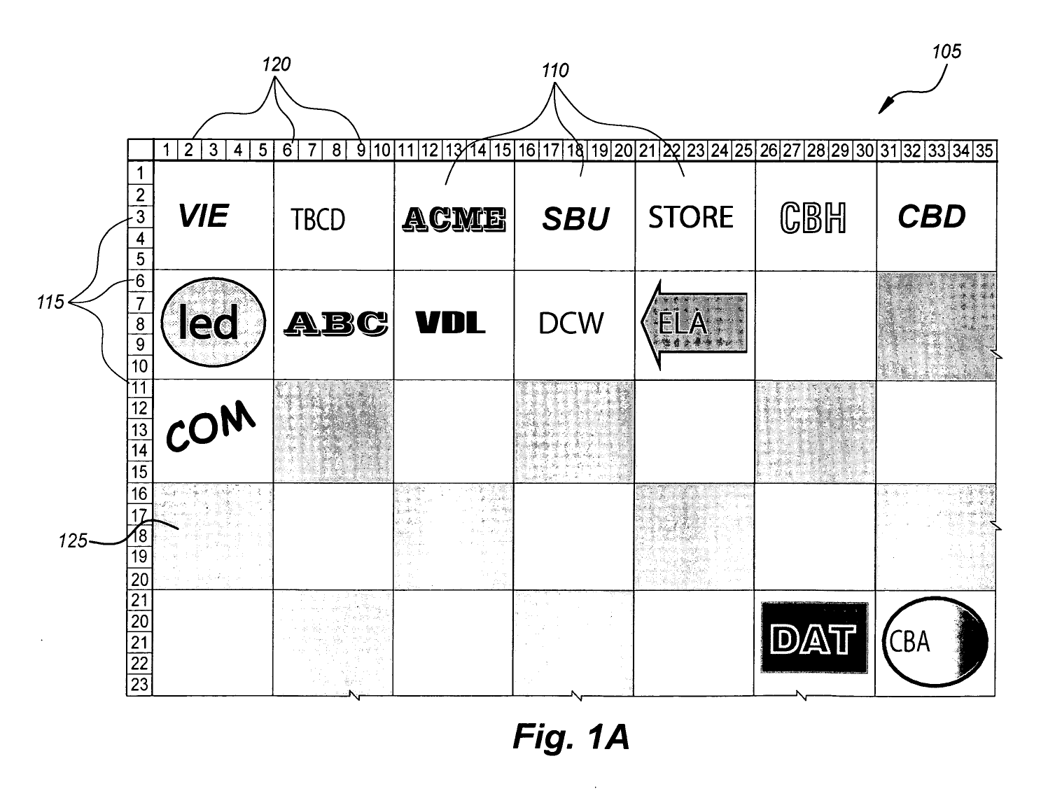

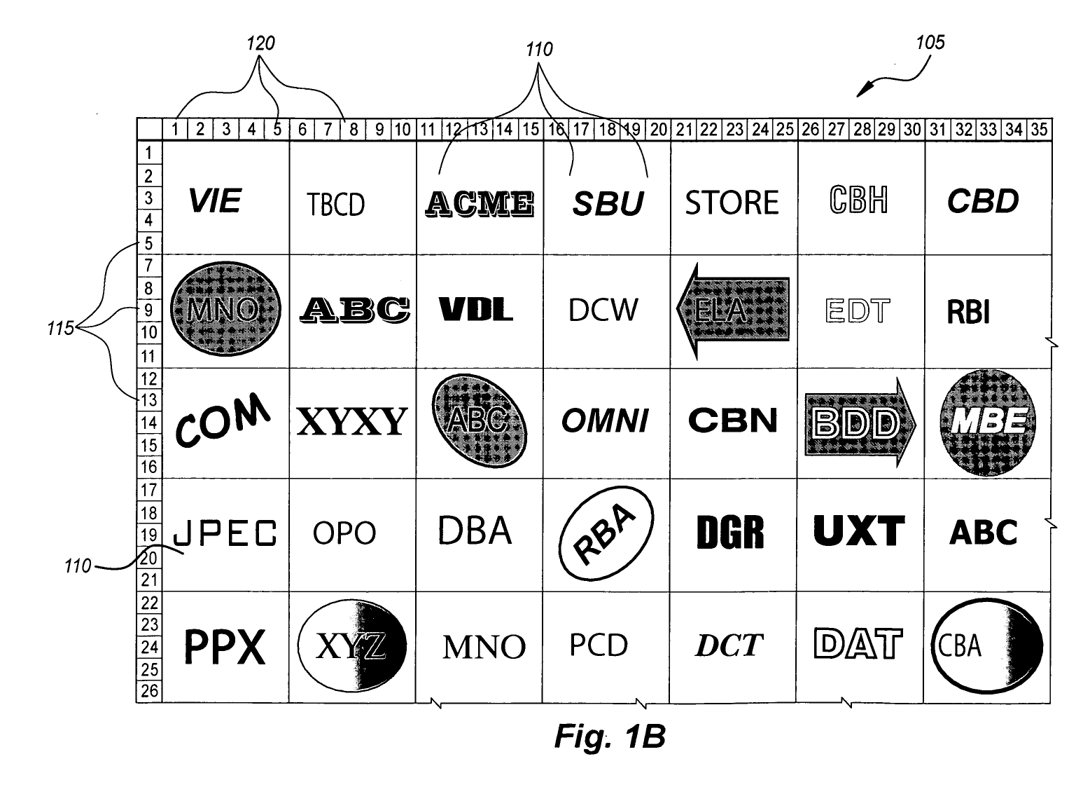

As shown in FIGS. 1A-3, the present invention is a method by which an incentive, i.e., prize drawing/gambling opportunity, is provided on an advertising website 105 to drive users to web pages belonging to advertisers being displayed as advertiser images 110 on the advertising website 105. To use the advertising website 105 and be eligible for the prize drawing, a user must pre-register with the site 105. A confirmation e-mail is generated to inform the user that he/she is registered with the site 105. Additional advertisements may be sent to the user via the confirmation and prize notification e-mails.

The prizes may be of some intrinsic value in order to provide online shoppers with a motivation, i.e., an attraction, to regularly visit and place orders through the advertising website 105. For example, the prizes may be in the form of cash. The prizes may be distributed periodically, e.g., daily. An initial prize may grow in real time as fast as the number of surfers and shoppers click or place an order through the website 105 because a predetermined percentage of income generated by the site 105 may be applied to the prize money.

When a registered user of the advertising website 105 mouses over a pixel block 125 displaying an advertiser's image 110, a specific unique coordinate set comprised of pixel block y-coordinate 115 and pixel block x-coordinate 120, defining the mouse cursor position at the time the user clicks on the image 110, is recorded as an entry into a winner selection table. Similarly, a plurality of users may select from the advertising images 110 and, thus, create their own entry into the winner selection table, i.e., the winner selection table contains entries from a plurality of users.

Pixel block size may be predetermined to maximize the number of advertisers on the advertising website 105, or alternatively, to present a more readable format on the website 105. In the embodiment shown, pixel block size is a 5×5 block of pixels per advertiser. An advertising page may have, e.g., 100×100 pixel blocks, i.e., 2.5×10⁵ pixels. Alternatively the page could have any other number of pixels that yields sufficient revenue to the service provider who provides the website 105. Thus, an ad placed in an upper left corner of the page may have coordinate designations (x, y) where x ranges from 1-5, and y ranges from 1-5. Similarly, an ad placed in a lower right corner of the page may have coordinate designations (x, y) where x ranges from 96-100 and y ranges from 96-100. Other embodiments may have a 10×10 block size. It should be understood, however that any pixel block size chosen is within the scope of the present invention.

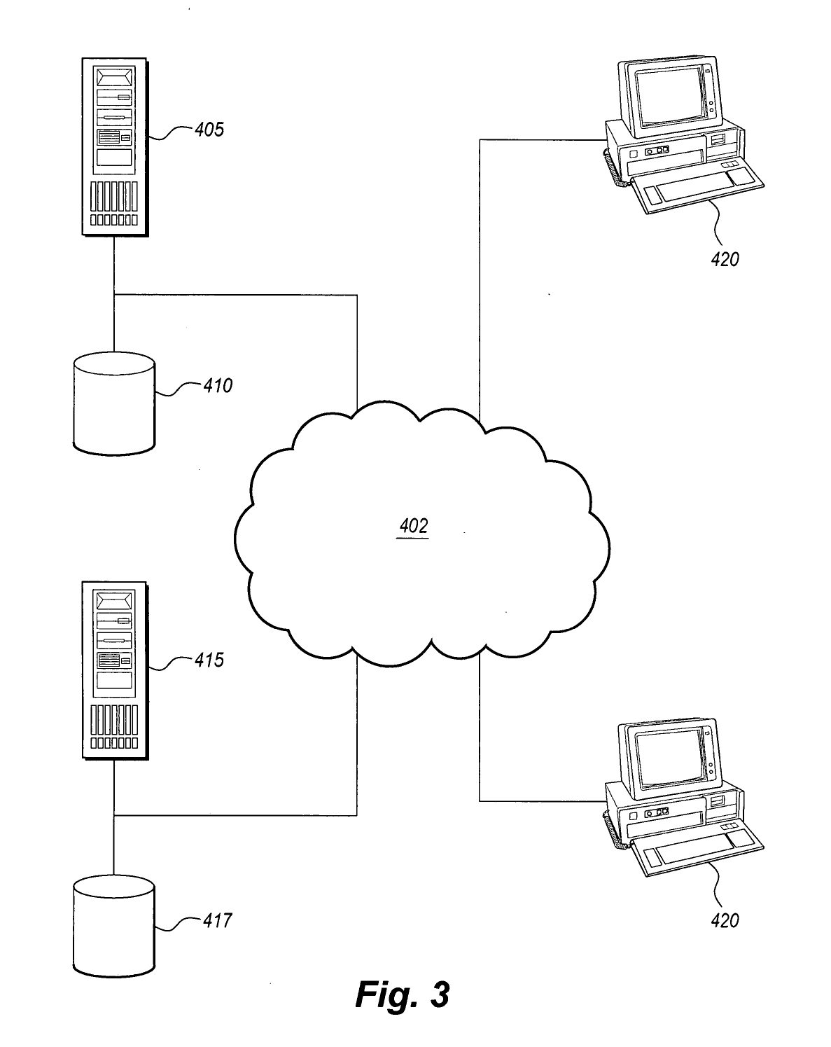

As shown in FIG. 3, the advertising website server 405 may include mass storage unit 410 for storing advertiser images 110, storing winning coordinate selection programs, and the like. Additionally, merchants, i.e., advertisers, may have their own server, such as server 415, that includes mass storage unit 417 for storing product information, user shopping carts, advertiser web site programs, and the like. Servers 405 and 415 are in operable communication with each other, and with the end user's computing system 420 via the Internet 402.

Users who create an entry into the winner selection table by clicking through to an advertiser's website may initiate an additional, server-generated entry by making a qualifying purchase on the advertiser's website. When the qualifying purchase is made, the merchant's server 415 notifies the advertising website server 405, and another entry into the winner selection table for that user is automatically generated. Thus, by continuing to shop at advertisers' websites, a user can increase his/her chances of winning a prize. Advertisers can also attract more customers by adding their own giveaways and to award these if the winning cell falls in their site and a winner is chosen.

After a predetermined time, e.g., on a daily basis, entries are closed and a winning coordinate set is determined. A winning coordinate selection algorithm may be implemented on the server 405, and may select a winning entry by picking from a table of random numbers, by generating a pseudorandom number set, or by hashing numbers generated from a preidentified sports event, gambling event, financial event, and the like (i.e., some future event having a result not under the control of the advertising website owner or the advertisers having advertisements posted on the advertising website in order to avoid claims of manipulation in choosing the prize winner). A winning combination may be determined from a hashing algorithm that uses digits from scores from a sporting event, which are sampled at predetermined intervals.

For example, in a basketball game, team A has a half time score of 35 and a final score of 98, while team B has a half time score of 42 and a final score of 80. The winning coordinate set may be determined by combining the least significant digit of half time winning/losing scores for the x coordinate, and combining the least significant digit of the final winning/losing score for the y coordinate, i.e., the winning coordinate set in this example is determined to be (52, 80).

Users who have entries that match the winning coordinate set are notified that they have won a prize, and prizes are distributed accordingly. Notwithstanding the prize distributions, the website 105 may have the capability of making money by way of pay-per-click method or pay-per-entry method, as well as on the additional advertisements that are delivered through the confirmation e-mails, which are sent to the drawing entrants.

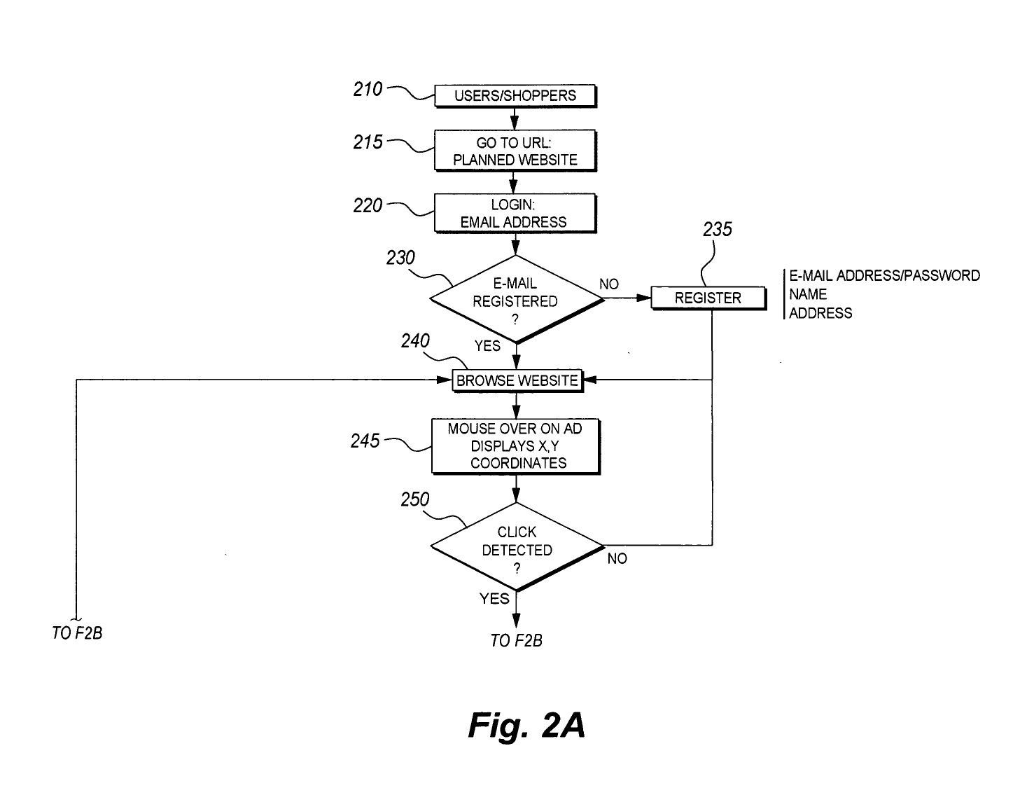

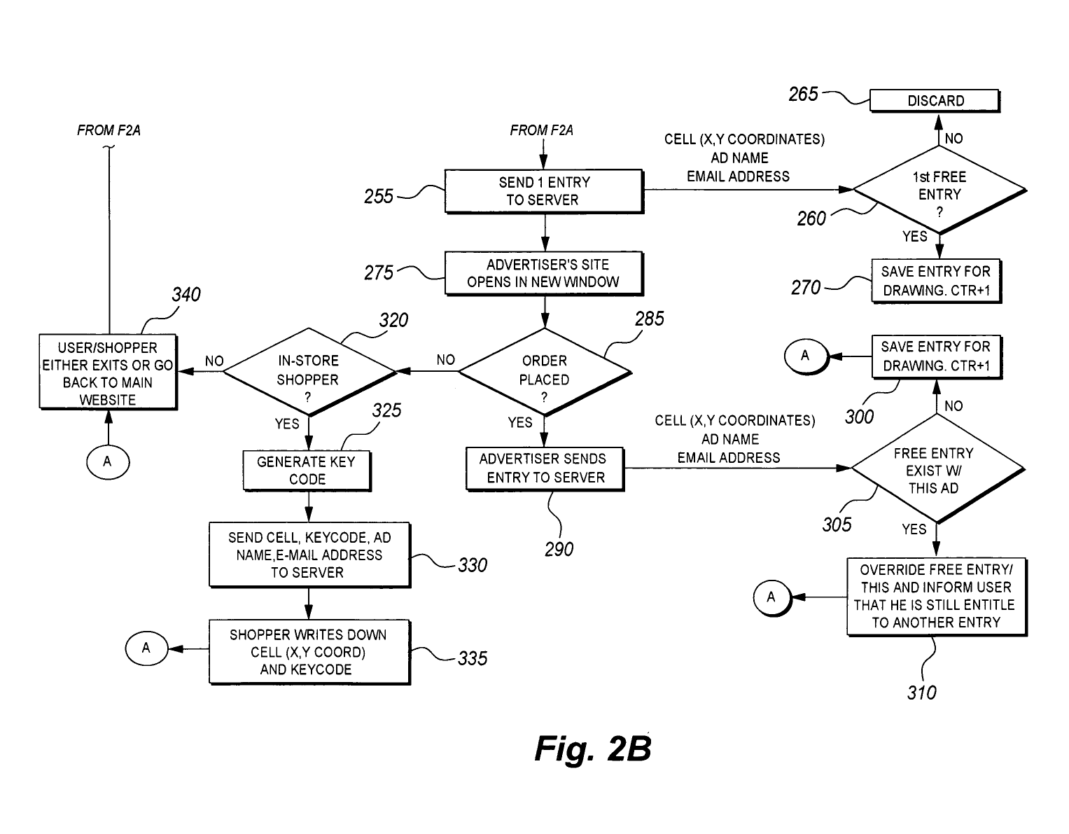

The process steps may be computer implemented, and are most clearly shown in FIGS. 2A-2B. The users/shoppers at step 210 visit the website 105 at step 215. The users login by using an e-mail address, as shown at step 220. As shown at step 230, a check is done to see if the e-mail address is registered. If the e-mail address is not registered, the user is encouraged to register, as shown at step 235. At step 240, the user may browse the website. At step 245, when a user mouses over the Ad displays 110, x- and y-coordinates of the Ad 110 are calculated.

According to step 250, if a mouse click is detected, then the process advances to step 255 where an entry is sent to the server 405. The entry comprises the x-coordinate 115 and the y-coordinate 120, Advertiser's name, and e-mail address of the user. As shown at steps 260, 265 and 270, only one free entry is initially permitted in the web advertising process. As shown in step 275, when a user clicks on an advertisement image 110, the advertiser's website may open in a new window. The user is permitted to browse through the advertiser's website. At step 285, a check is performed to see if the user has ordered anything form the advertiser's website.

If the user has ordered something, then at step 290 the advertiser (as aforementioned, via the advertiser server 415) sends an entry to the advertising website server 405, the entry comprising x-coordinate 115 and y-coordinate 120, advertiser name, and e-mail address of the user. As shown at steps 305, 300, and 310 an additional free entry may be entered on behalf of the user if the entry is permitted by the current advertiser (free in the sense that the user must place an order for merchandise or services, but there is no additional charge for making another entry into the winner selection table).

Referring again to step 285, if an order has not been placed, a check is performed at subsequent step 320 to determine if the user is an in-store shopper. As shown in step 340, non-in-store shoppers who have not purchased anything may either go back to the advertising website 105 or exit the system.

In-store shoppers who are web-browsing anywhere may also participate in the drawing. As shown in step 325, a key code is generated for the in-store shopper. An x- and y-coordinate set is automatically generated, and, as shown at step 330, the coordinate set (115, 120), key code, advertiser name, and user's e-mail address are sent to the advertising website server 405 for entry into the drawing.

The in-store shopper writes or otherwise records the coordinate set 115, 120 and key code. Upon checkout the in-store shopper gives the coordinate set 115, 120, as well as the key code to the cashier. The cell, i.e., coordinate set 115, 120, and the key code may only be used in the same store that the user received the coordinate set/key code combination from.

It is to be understood that the present invention is not limited to the embodiment described above, but encompasses any and all embodiments within the scope of the following claims.

I claim:

1. A computer implemented advertising method for a website, comprising the steps of:
disposing a plurality of advertiser images on a plurality of web pages, each of the advertiser images having a unique block of coordinates defining a location of the image on the web page the image is located on, each of the advertiser images being representative of a click-through link to a respective advertiser's website;
registering a user for participation in a gambling opportunity based on user selection of any of the plurality of advertiser images;
recording a specific coordinate set of a unique block related to the user selection of the any of the plurality of advertiser images, the recording being an entry into a winner selection table;
recording entries into the winner selection table from a plurality of registered users;
determining at least one winning coordinate set;
matching the winning coordinate set with a corresponding one of the entries in the winner selection table;
notifying the at least one user associated with the matching entry that the user has won a prize; and
distributing the prize to the user associated with the matching entry.

2. The computer implemented advertising method according to claim 1, wherein the step of recording a specific coordinate set further comprises recording mouse click pixel coordinates corresponding to a position on the advertising image selected by a mouse click by the registered user.

3. The computer implemented advertising method according to claim 1, further comprising the step of generating a confirmation e-mail informing the user that the user is registered with the site.

4. The computer implemented advertising method according to claim 1, further comprising the step of predetermining a fixed size for each of the unique blocks of coordinates defining the advertiser image locations.

5. The computer implemented advertising method according to claim 1, further comprising the step of providing interoperable communication between the advertising website, merchants' website and end-user computing systems.

6. The computer implemented advertising method according to claim 1, further comprising the step recording an additional entry into the winner selection table for the registered user when the registered user clicks through to the advertiser's website and makes a qualifying purchase on the advertiser's website.

7. The computer implemented advertising method according to claim 1, further comprising the step of providing a table of random numbers from which the winning entry is determined.

8. The computer implemented advertising method according to claim 1, further comprising the step of generating a pseudorandom number set from which the winning entry is determined.

9. The computer implemented advertising method according to claim 1, further comprising the step of hashing numbers generated from a pre-identified event from which the winning entry is determined.

10. The computer implemented advertising method according to claim 9, further comprising the step of determining a winning combination from a hashing algorithm that uses digits from scores from a sporting event, which are sampled, at predetermined intervals.

11. The computer implemented advertising method according to claim 10, further comprising the steps of:
recording a half time numeric score of a first team in a game;
recording a half time numeric score of a second team in a game;
recording a final score of the first team in the game;
recording a final score of the second team in the game; and
determining the winning coordinate set based on the half time winning and losing scores of the teams and the final winning and losing scores of the teams.

12. The computer implemented advertising method according to claim 11, wherein the step of determining the winning coordinate set based on the half time winning and losing scores further comprises the steps of:
appending the least significant digit of half time score of the second team to the least significant digit of half time score of the first team in order to create the x-coordinate of the winning coordinate set; and
appending the least significant digit of the final score of the second team to the least significant digit of the final score of the first team in order to create the y-coordinate of the winning coordinate set.
